(19) United States
(12) Patent Application Publication
(10) Pub. No.: US 2009/0006531 A1
(43) Pub. Date: Jan. 1, 2009

(54) CLIENT REQUEST BASED LOAD BALANCING

(75) Inventors: Eliot C. Gillum, Mountain View, CA (US); Jason A. Anderson, Sunnyvale, CA (US); Jason D. Walter, San Jose, CA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 11/770,439

(22) Filed: Jun. 28, 2007

(51) Int. Cl. G06F 15/16

(52) U.S. Cl. 709/203

(57) ABSTRACT

A method for balancing load in a network system, having a plurality of clients initiating transactions with a plurality of servers. For each transaction a host name associated with one or more servers capable of completing the transaction is specified. The client initiates a request to resolve the host name and a plurality of IP addresses are returned. The client randomly communicates with one of the IPs identified as capable of completing the transaction and reports on the success of the transaction. If multiple attempts to the same IP fail, the IP is removed from service by the client.

### BACKGROUND

Companies which provide services to users via the Internet make use of large controlled network environments such as datacenters. Datacenters consist of a number of servers generally organized in a manner the provider deems most efficient to make their provision of the company's service to users both responsive and seamless. Examples of such services include email services such as Microsoft Live Hotmail and shopping services such as Amazon.com.

In these examples, service providers direct users running web-browsers to a cluster of computers which may provide an interface to more data stored on other servers within the company's system. For example, an email service provider may direct users to a series of web servers which provide email application interface to the user via the web-browser interface. The web servers themselves then initiate requests to other servers in the datacenter for the information sought by a particular user. In this example, the web servers are essentially clients of the servers to whom they make requests.

For large scale internet service providers, the web servers are typically separated from storage servers, and there are generally many machines of each type. Information flow within the datacenter is managed by the service provider to create efficiency and balance the load amongst the servers in the datacenter, and even across physically separated datacenters. This may be accomplished by any number of network components which manage traffic flow to the servers. Typically, such components may include components which are specifically designed to ensure traffic to the server is balanced amongst the various servers in the system.

FIG. 1 is a depiction of networking environment such as a datacenter 100 which includes a number of client computers 110A-110E which initiate transactions with a number of backend servers 120A-120C. In the networking environment 100, a load balancing component 150 exists to arbitrate transactions which originate from clients 110A-110E sent to servers 120A-120C. Load balancing component 150 ensures that the transactional load originating from clients 110A-110E is relatively balanced amongst the servers. Any number of suitable configurations exists for setting up an environment 100.

Such management of load balancing by dedicated components designed for such tasks creates scaling problems for the enterprise. In some schemes, when the servers are routed through a network component, failure by the component affects access to those devices it controls. Further, many network components which manage load balancing in such environments use artificial probes on each server to determine such things as the server traffic and whether the server is operating properly.

### SUMMARY

Load balancing is accomplished by routing transactions within the environment based on Domain Name Service (DNS) queries indicating which servers within the environment are available to respond to a request from a client. Multiple server IPs are provided and a client picks one of the IPs to conduct a transaction with. Based on whether transactions with servers at each IP succeed or fail, each client determines whether to make additional requests to the server at the IP. Each client maintains its own record of servers which are servicing requests and load-balancing activities within the environment are thereby distributed.

In one aspect, the technology is a method for balancing load in a network system, the system including a plurality of clients initiating transactions with a plurality of servers. For each transaction a name associated with one or more servers capable of completing the transaction is specified. The client initiates a request to resolve the host name and a plurality of IP addresses are returned. The client randomly communicates with one of the IPs identified as capable of completing the transaction and reports on the success of the transaction. If multiple attempts to the same IP fail, the IP is removed from service by the client.

The present technology can be accomplished using hardware, software, or a combination of both hardware and software. The software used for the present technology is stored on one or more processor readable storage media including hard disk drives, CD-ROMs, DVDs, optical disks, floppy disks, tape drives, RAM, ROM or other suitable storage devices. In alternative embodiments, some or all of the software can be replaced by dedicated hardware including custom integrated circuits, gate arrays, FPGAs, PLDs, and special purpose computers.

These and other objects and advantages of the present technology will appear more clearly from the following description in which the preferred embodiment of the technology has been set forth in conjunction with the drawings.

### BRIEF DESCRIPTION OF THE DRAWINGS

FIG. 1 is a block level diagram of a load balancing system in a controlled network environment.

FIG. 2 is a block level diagram of a system suitable for implementing the present technology.

FIG. 3 is a flowchart illustrating one embodiment of a method of the present technology.

FIG. 4 is a block level diagram of a second system suitable for implementing the present technology.

FIG. 5 is a flowchart illustrating an alternative embodiment of the present technology.

FIG. 6 is a block diagram of another implementation of the technology disclosed herein.

FIGS. 7A and 7B are flowcharts illustrating the methods performed by the implementation of FIG. 6.

FIG. 8 depicts a processing device suitable for implementing computers, servers and other processing devices in accordance with the present technology.

### DETAILED DESCRIPTION

The technology provides a method for balancing network traffic in a controlled network environment. Load balancing is accomplished by routing transactions within the environment based on DNS queries from the client indicating which servers within the environment are available to respond to a request from a client. Multiple server IPs are provided and a client randomly picks one of the IPs to conduct a transaction with. If the transaction with the server at the IP fails, the IP may be taken out of service by the client requesting the transaction. These actions are consistent across all clients in a controlled networking environment ensuring that network load is balanced by the clients themselves and the DNS records provided under the control of the environment administrator.

While the technology will be described below with respect to a transaction processing environment where transaction requests are managed and directed using DNS and TCP/IP services, the technology is not limited to these environments. In particular, the technology may be implemented with any directory service enabling routing to a network endpoint, including but not limited to Service Oriented Architecture Protocol (SOAP) or endpoints such as MAC addresses.

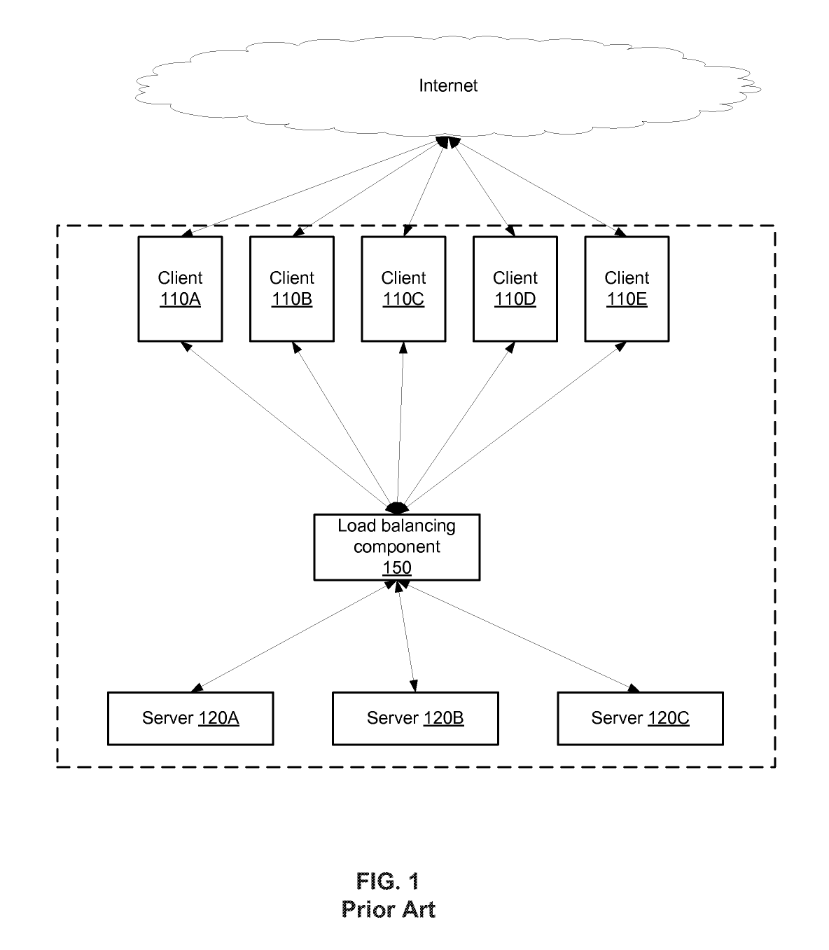

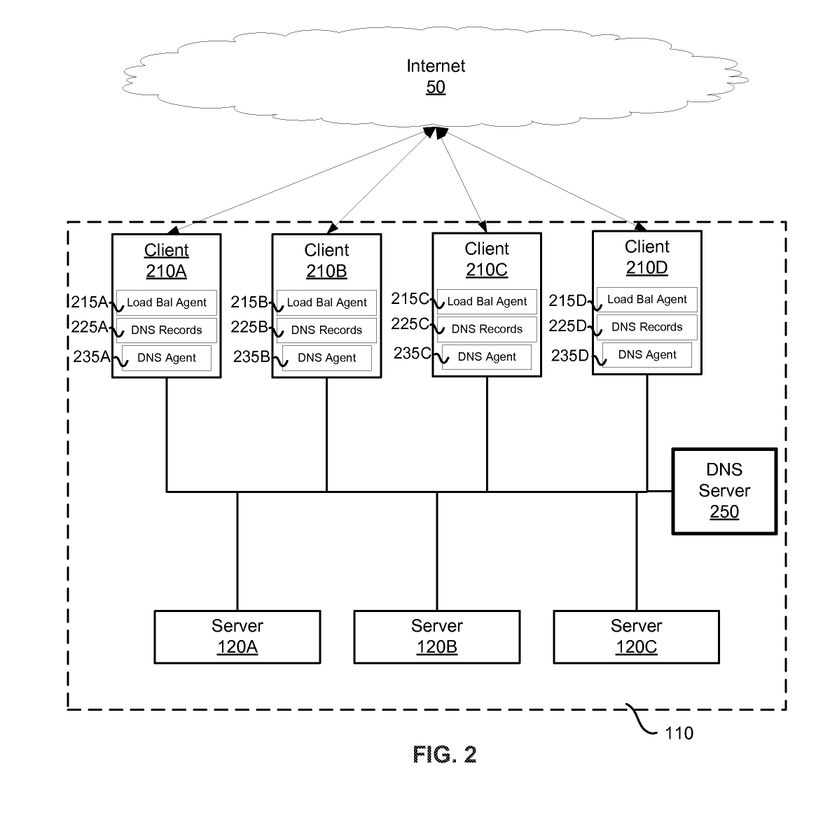

FIG. 2 shows a system environment 110 in which the present technology is implemented. In accordance with the technology, load balancing agents are distributed on each of clients 210A-210D. Client 210A includes a load balancing agent 235A, client 210B includes a load balancing agent 235B, client 210C includes a load balancing 235C, and client 210D includes a load balancing agent 235D. Each client 210 also includes a Domain Name Service (DNS) agent 215 and a local cache of DNS records 225. A DNS server 250 is provided within the computing environment 110 and operates under the control of the administrator of the computing environment 110. Servers 120A-120C remain unchanged in this configuration. Each DNS agent 215A-215D operates in accordance with standard DNS principles. DNS is an internet service that translates domain names into IP addresses. In order to complete transactions within a system of FIG. 2, each client and server has an IP address which is accessible to other computers in the system 110. Every time a transaction on a client 210A-210D requires access to one of the servers, it requires the IP address of that server to know where to direct a transaction. In FIG. 1, this may be controlled by the load balancing component. In the system of FIG. 2, this can be controlled by the load balancing agents on each of the clients.

As will be generally understood, a DNS server 250 comprises a name server which can be either a dedicated device or software processes running on a dedicated device that store manage information about domains and respond to resolution requests from the clients. DNS server 250 stores name data and associated records about each particular name. The main DNS standards, RFCs 1034 and 1035, define a number of resource record types which the DNS server may provide. These include address or A records containing a 32-bit IP address of a machine, name server (NS) records which specify the DNS name of a server that is authoritative for a particular zone, and mail exchange (MX) records which specify the location that is responsible for handling an e mail sent to a particular domain.

The DNS agents 215A-215D perform resolution by taking a DNS name as input and determining corresponding address records (A, MX, etc.) based on the nature of the resolution request.

Techniques for managing a data center, or traffic within the data center, have been implemented where the location of a particular set of data, such as a user's e-mail data, is found by first determining the name location for that user and determining a set or subset of servers to interact with based on a DNS record identity for that user. See, for example United States Patent Publication 2006/0174033.

In the present technology, the load balancing agents replace the hardware load balancer 150. The load balancing agent is a library that is called from each client application that would normally talk to a server 120A-120C. A client application running on one of clients 210A-210D request a server address by providing the DNS agent with a name location for a server it is trying to reach. The DNS agent will return a list of IP addresses for suitable servers which can handle this transaction. These IP addresses may be represented as DNS A records or DNS MX records. An application operating on one of the clients will then attempt to contact one of the servers which is available for servicing the request. If the transactions fail after a certain number of attempts, the application will report this back to the load balancing agent. If application semantics are such that retries are possible, then retries should go to different servers. This protects not just the logical request, but also the servers from getting falsely marked as “bad” because of a misbehaving transaction.

The DNS record identifying available servers generally provides more than one IP for the name record resolved. The DNS resolver in such case will randomly pick one of the returned addresses, and such randomness ensures that the set of IPs (which will be sent to any number of clients) will have a distributed load.

In one implementation, the load balancing agent is implemented as a library that is called from each client application that would normally talk to a server through a hardware load balancer. Each client application requests an IP address to conduct a transaction with by providing a name of a server. In a mail routing environment, this address may be the storage location of a user's data, as outlined in Patent Application Publication 2006/0174033. The client will be provided with a series of IP addresses and the client application then performs its request and reports back to the load balancing agent whether the request succeeded. The client determines what constitutes “success” and “failure”. The agent keeps track of failures and successes per real IP address, and uses this data to determine which IPs are currently available for the next client application request. The load balancing agent may communicate with the client's native DNS services to get the list of real IPs for a server application. These IPs are represented as DNS A, MX records or other DNS records and can be updated by updating a DNS server or by a managed address file sent to the client or managed DNS servers. The TTL of the A record determines the frequency load balancing agent queries DNS for any updates. If DNS is not available, the load balancing agent continues to use the last known set of IPs. The load balancing agent may locally store “last state” which records the known IPs and which can be used if it is unable to query DNS on start up if DNS is unavailable.

A server IP is marked as “down” if a client's attempt to transact with a server fails after too many consecutive attempts. The number of failures is configurable. The load balancing agent can then return the IP to service after a specified delay or by forming an artificial probe. In one implementation, it will determine if the real IP is available by a callback to the client application requesting a transaction by the client to the IP. The advantage to the callback method is the client queriess are less likely to fail while trying to test if the real IP is running again.

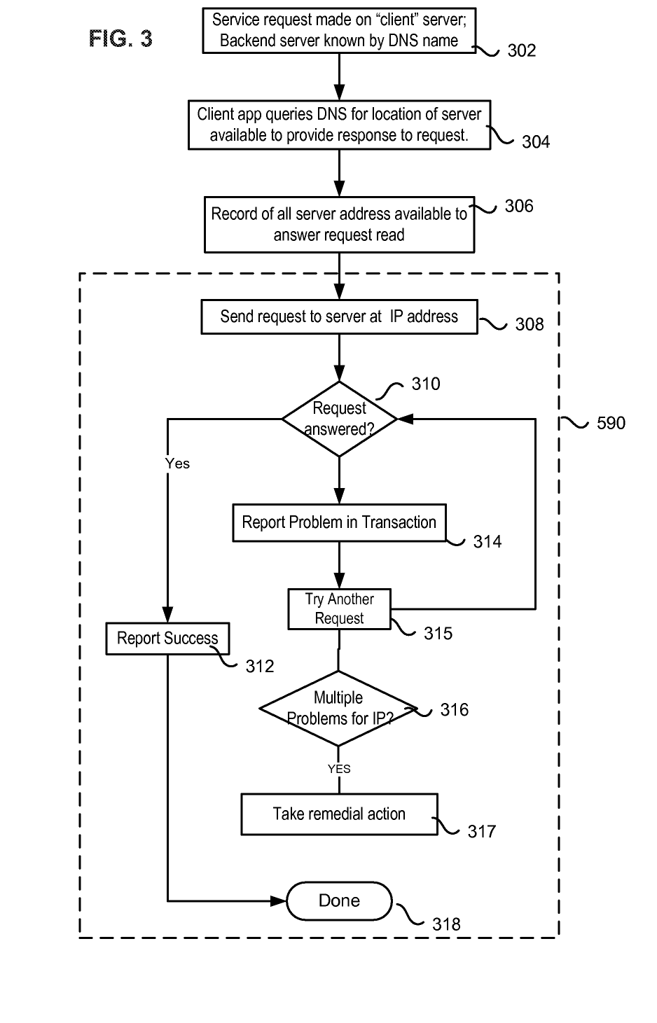

FIG. 3 is a flowchart representing a general method in accordance with the technology discussed herein.

At step 302, a service request is made on a client server such as client 210A-210D. An application running on client 210A-210D will normally query a DNS agent for the location of a server or servers available to provide a response to its service request at step 304.

In one implementation, as discussed above, the load balancing agent will respond to the client application at step 306 with a record of all server addresses available to answer the transaction. However, other implementations of the method do not require a load balancing agent. The addresses may be returned directly from the native DNS service on the client which obtains records from DNS server 250 or the internal cache of the DNS agent. It should be noted that calls to the DNS servers are made only when the time to life record (TTL) indicates that the records are expired.

At step 308, the client will send a transaction request to one of the servers at an IP address it has received. After the request is made to the internal address at step 308, the client will determine at step 310 whether the request has been answered. If the request has been answered, the transaction is completed and the success of the transaction is reported at step 312. The method is done at step 318. If the request is not answered or returns an error at step 310, the failure is reported to the load balancer agent at step 314. At step 315 the request is repeated to the same server or a different server. Repeating the request to a different server at step 315 ensures that the failure is not linked to the specific transaction attempted at the server. Whether another transaction attempt is made, and whether it is made to a different IP, may depend on whether or not more than one record is provided for each name and the configuration of the transaction request. The number of attempts made to the same or different IPs may be governed by the load balancing agent, the DNS agent, the client application, or in combination of the three. At step 316, if some number of consecutive transactions to the same IP fail, remedial action may be taken on the server at the IP address at step 317. In one embodiment, remedial action is taken after three consecutive transactions directed to the same IP fail.

Remedial action at step 317 can include the client preventing transactions from being directed to the server at the problem IP for some time, and/or directing a probe back to the server at the failing IP after such time to determine whether the server is servicing transaction requests. The probe may be in the form of a callback made to an application on the client which can initiate a non-critical transaction request, the success of which can indicate whether the server can be put back in service. Such requests may include an ICMP protocol ping, a disc read request, or the like. Implementations of such request should represent client requests as closely as possible so as to avoid prematurely in-servicing a server which, for instance, may respond to a ping but not application request

It should be noted that a unique feature of the present technology is that the load balancing across the plurality of clients and servers is controlled individually at each particular client. Load balancing occurs on each client which is making decisions for itself about which servers to communicate with. Each client determines when and if to move to a particular server with an additional request. By having all clients behave independently, a non-binary back off of troublesome servers is achieved. For instance, if one particular client decides to refrain from sending transactions to a particular server or a series of servers, and another client continues initiating requests to the server, the servers which are compromised but not completely disabled may continue functioning within the system. This avoids a classic problem of traditional load balancers that, when faced with high load, can spiral into complete failure as more and more servers go out of service from being slightly overloaded.

Another unique feature of the technology is that the load balancing system results when there are a large number of transactions amongst a large number of clients and servers, all of which occur rapidly. It will be understood by one of average skill in the art that the load balancing technology disclosed herein is more effective than a centralized load balancing component when the transaction rate between clients and servers in the system exceeds the frequency that the load balancing component determines server load and availability. Normally, where a large number of transactions take place, such as, for example in a data center, the high volume of transactions allows the technology to distribute the load balancing to all of the client applications and detect problems in the network much more quickly than in centralized technology.

In addition, in a system using a centralized load balancer, server back-offs controlled by the load balancer are generally made to all clients. In the distributed technology disclosed herein, only a portion of clients (those detecting problems) stop using that server; for other clients, the server is recognized as available. This allows the system as a whole to better utilize each server's current transactional capacity. This also improves the health of the system in that fractional server loads can be fully utilized. Consider where 5 servers are to be load balanced, and one of the 5 for some reason has a reduced capacity. A central binary back off would result in a 20% capacity decrease to the system by preventing transactions reaching the crippled server. This in turn would add 5% increased capacity to each of the 4 remaining servers, placing a strain on those servers. Also when a server is centrally brought back online, it may be stressed with numerous transactions which can cause it to fail again. With client distributed load balancing agents, some fraction of the clients will stop using the reduced capacity server, meaning the overall system capacity decreases by a smaller amount and only marginally increasing load to the remaining servers.

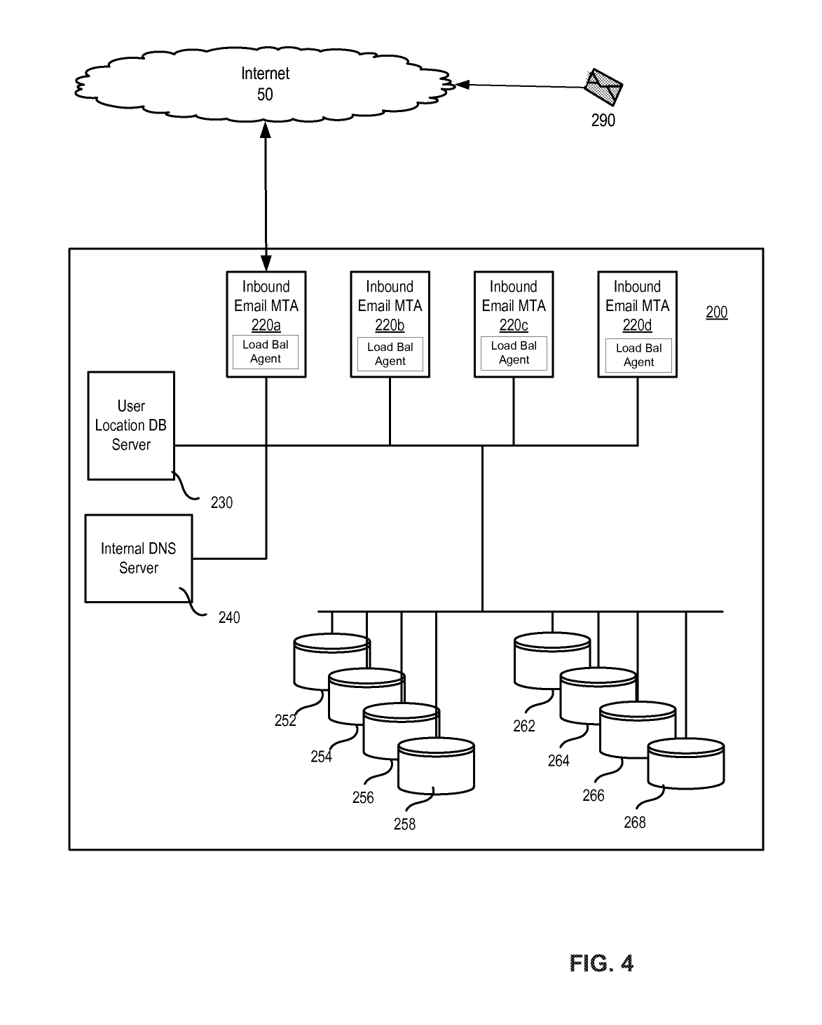

FIG. 4 illustrates and exemplary embodiment of a use of the system of the present technology. FIG. 4 is a block level diagram of a system suitable for implementing a web-based service, and in particular a web-based e-mail system. System 200 allows users to access and receive e-mail via the internet 50. System 200 which may be implemented by an e-mail service provider (ESP) may consist of, for example, a number of inbound e-mail MTAs 220a, 220b, 220c, 220d, a user location database server 230, a DNS server 240, spooling mail transfer agents 222, 224, and user mail storage units 252, 254, 256, 258, 262, 264, 266, 268. Each of the MTAs may include a load balancing agent as disclosed herein. E-mail messages 290 which are inbound to the system 200 must be stored in specific user locations on the mail storage units 252, 254, 256, 258, 262, 264, 266, 268. The technology disclosed herein ensures that distribution of processes from the MTAs to the storage units is balanced over the system.

It should be understood that the system of FIG. 4 may also include a plurality of outbound mail transfer agents, a plurality of web servers providing web-based email applications to the system's users, other email application servers such as POP and IMAP servers allowing users to access their accounts within the system, as well as administrative servers. Load balancing agents may be distributed to each of these types of servers as well.

Each inbound e-mail MTA 220 is essentially a client or front end server to which e-mails 290 are directed. Upon receipt of a mail message for a user, the MTA routing application determines a user's storage location to direct the mail within the system to the user's storage location(s) on the storage units 252, 254, 256, 258, 262, 264, 266, 268. In one embodiment, the user location is provided in the form of a DNS name which may be resolved into a storage location for each individual user. DNS server 240 stores the internal routing records for system 200. As noted above, these records can be in the form of A records, MX records or other types of records. In accordance with the present technology, the inbound e-mail MTAs 220 resolve the DNS name of the user location to determine the delivery location and the data storage units 252, 254, 256, 258, 262, 264, 266, 268 for a given user, and request a mail storage transaction to route an incoming e-mail to the data storage units.

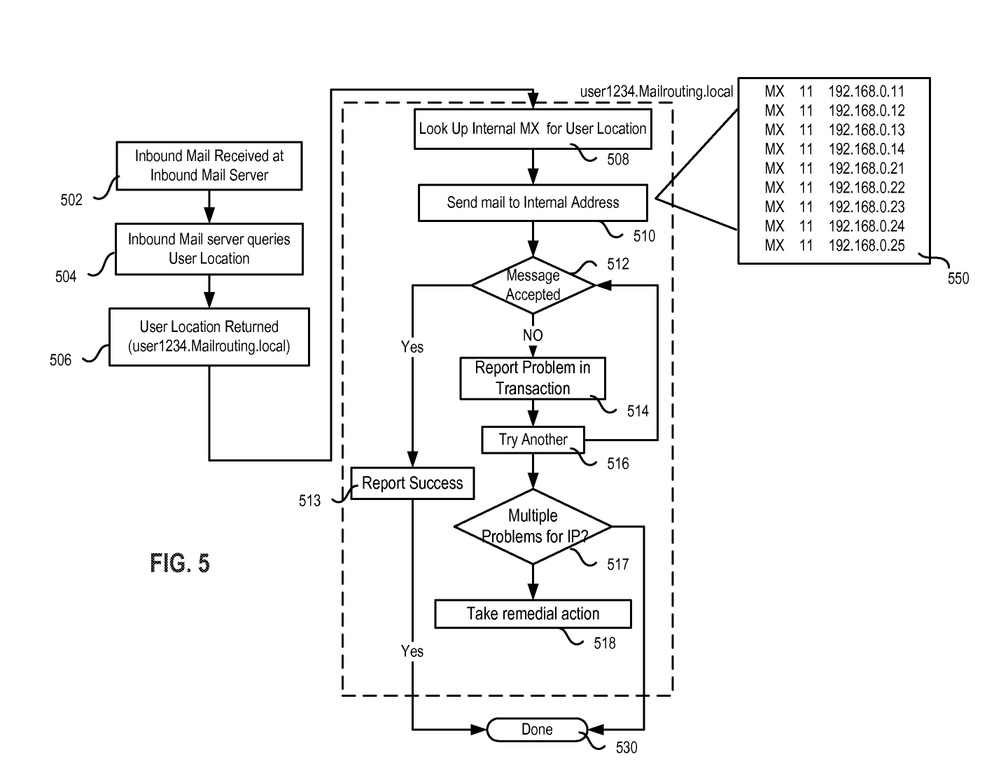

FIG. 5 illustrates a method in accordance with the present technology for routing an email in accordance with the system of FIG. 4. At step 502, an inbound e-mail is received at the inbound mail server. At step 504, the inbound mail server queries the user ID database for the user location, and receives a domain name location specifying the location of the user's data on the data storage units 252, 254, 256, 258, 262, 264, 266, 268 at step 506. At step 508, the internal DNS server 240 is queried to determine an internal MX mail routing record for the routing domain. The MX record shown in box 550 in FIG. 5, includes a plurality of records at priority 11, indicating to the system that any one of the priority 11 records may be utilized for the storage location for the particular user. In accordance with the technology, each of the returned addresses is a “real” server address within the system. Each real address is dedicated to a server which is designed to accommodate the query provided by the client application on the inbound e-mail MTA seeking to deliver the message. At step 510, the inbound e-mail MTA attempts to send the mail and store the location at the identified internal address. At step 512, if the message is accepted, the transaction success is reported to the load balancer at 513. If the message is not accepted then at step 514, the failure is reported to the load balancing agent at 516 and an alternative IP address identified in block 550 will be tried at step 516. After some number of consecutive failed transactions to an IP address are detected at step 517, the load balancer application takes remedial action at step 518 in a manner similar to that described above with respect to FIG. 3.

A number of mechanisms may be utilized to provide the address record information to each of the load balancing agents in the system. In one case, a client application will always use a local DNS server, such as internal DNS server 240, whose records are updated by a system administrator. When a client application seeks available IP addresses for a particular transaction, this location is looked up in the local DNS and A records or MX records for IPs for the client application to use are returned. These records may be retained in the client's DNS cache until the TTL expires and the client queries the local DNS server for an update.

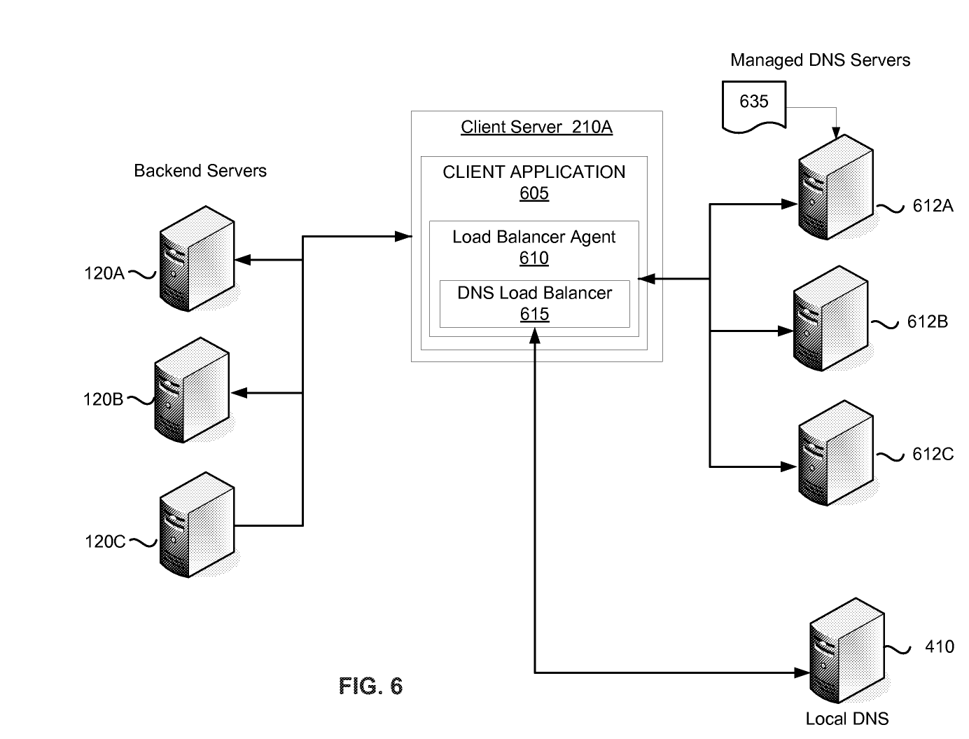

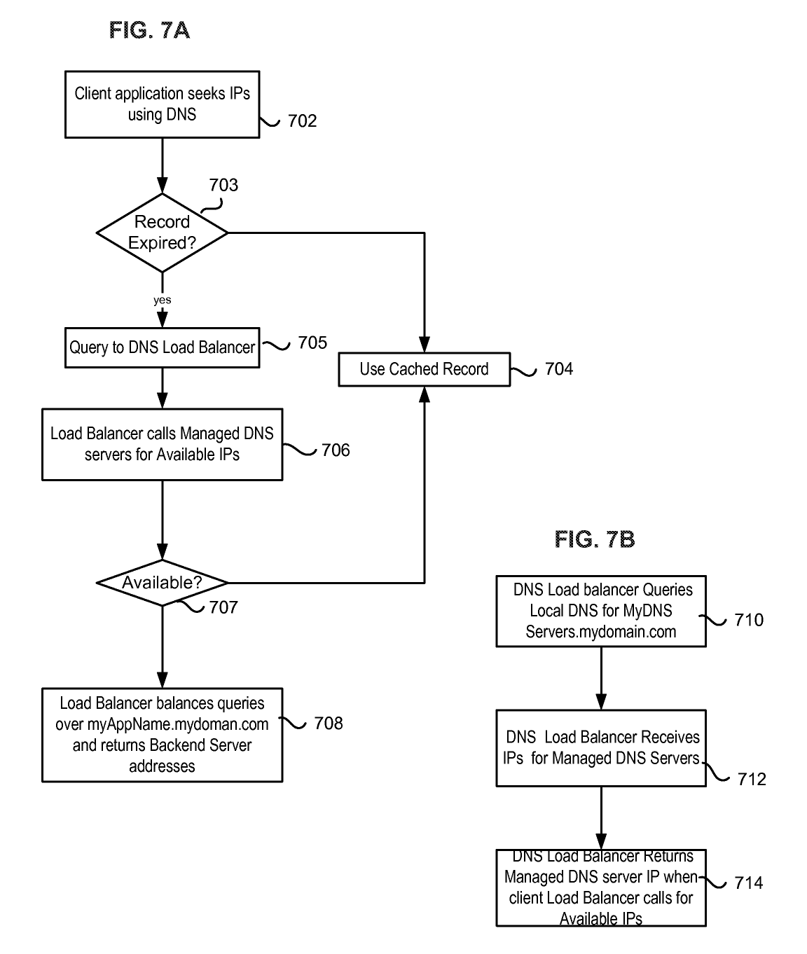

FIGS. 6, 7A, and 7B illustrate an alternative embodiment for implementing a DNS load balancer in conjunction with the load balancing agent. In this embodiment, the DNS load balancer is a load balancer agent that is used by client load balancer agents to direct requests to managed DNS servers. The DNS load balancer can re-direct queries to directly managed DNS servers which may be updated more quickly than a local DNS server. Using this configuration, a zone management file 635 may be downloaded to management DNS servers 612A, 612B and 612C more quickly than records can be updated in a system's DNS server. As shown in FIG. 6, the client device 210A includes a client application 605, the load balancer agent 610, and a DNS load balancer 615. Managed DNS server 612A, 612B and 612C communicate with the load balancer application, while the DNS load balancer 615 communicates with the local DNS server 410. The managed DNS servers provide records for available backend servers, while the Local DNS server identifies which managed DNS servers should be used by the load balancer agent.

As illustrated in FIG. 7A, when a client application seeks IPs for use in conjunction with completing a transaction request at step 702, the load balancing agent first checks the cached record at step 703 and if the record is not expired, it is returned at step 704. If the record is expired, the client load balancing agent calls the DNS Load Balancer for managed DNS servers having available IPs at step 705. Next, at step 706, the load balancing agent queries the managed domain name servers. If the servers are not available, the cached record is used. If the servers are available, step 708 the load balancing agent returns backend server addresses for backend servers 120A-120C.

As illustrated in FIG. 7B, at step 710 when cached managed DNS records of the DNS load balancer are expired, the DNS load balancer queries the local DNS server for which of the managed DNS servers the client application should use. The DNS load balancer receives IPs for the managed DNS servers at step 712, and at step 714, the DNS load balancer returns managed DNS server IPs when the load balancing agent needs to refresh its records during calls for available IPs. The DNS load balancing agent will look up the DNS server name as a fully qualifying domain name in local DNS and get back a list of A records that have IP addresses for the DNS servers that the client manages. The client load balancing agent will then load balance over these DNS servers and will get A records corresponding to the available backend servers when the client application calls for available backend servers.

Use of DNS in transaction routing allows additional benefits. In particular, zone management can be utilized to update records in the DNS servers when transaction servers are placed into or taken out of service. This can be accomplished using well known DNS zone transfer operations or though the use of a dedicated zone administration application. In the latter instance, instead of using a master/slave relationship between various DNS servers in the system, each DNS server may receive a zone management file from a dedicated management server configured by a system administrator. Using this configuration, a zone management file 635 may be downloaded to management DNS servers 612A, 612B and 612C more quickly than records can be updated in a system's DNS server. The zone configuration file may be input to the manage DNS servers to alter the use of the backend servers. The zone file can change the DNS information provided by the manage DNS servers in the real time. The zone file can be used to add or remove entries at any time, allowing the operations administrator to control which backend servers are in and out of service.

The DNS specification allows setting separate refresh and expiration values for records. In the present technology, it is advantageous to provide very large expiration values and very small refresh values. This allows IP addresses to be updated very quickly, while preventing failures which may result from DNS servers being unavailable to a client application. Note that the refresh value cannot be so small as to cause significant overhead for the application or overwhelm the DNS server. Appropriate values for a given system would be readily apparent to someone skilled in the art.

In an alternative embodiment, the records may provide weighting information for the IP addresses. Where, for example, different servers are capable of handling different levels of load, those servers having a higher level of load may have more or different transactions directed to them by weighting the records. This weighting information may be provided in number of ways, including simply adding multiple entries for the same address in the record returned.

It should be further recognized that the IP addresses returned in the above example point to virtual servers or “real” computing devices. A virtual IP may itself provide series of transactions to another cluster of computing devices, allowing the technology herein to be combined with other forms of load balancing in the network environment. Moreover, while the technology has been discussed with respect to a datacenter, the technology could be applied to any set of clients and servers operating under the control of an administrative authority or wherever clients could otherwise be expected to have and properly use a load balancing agent.

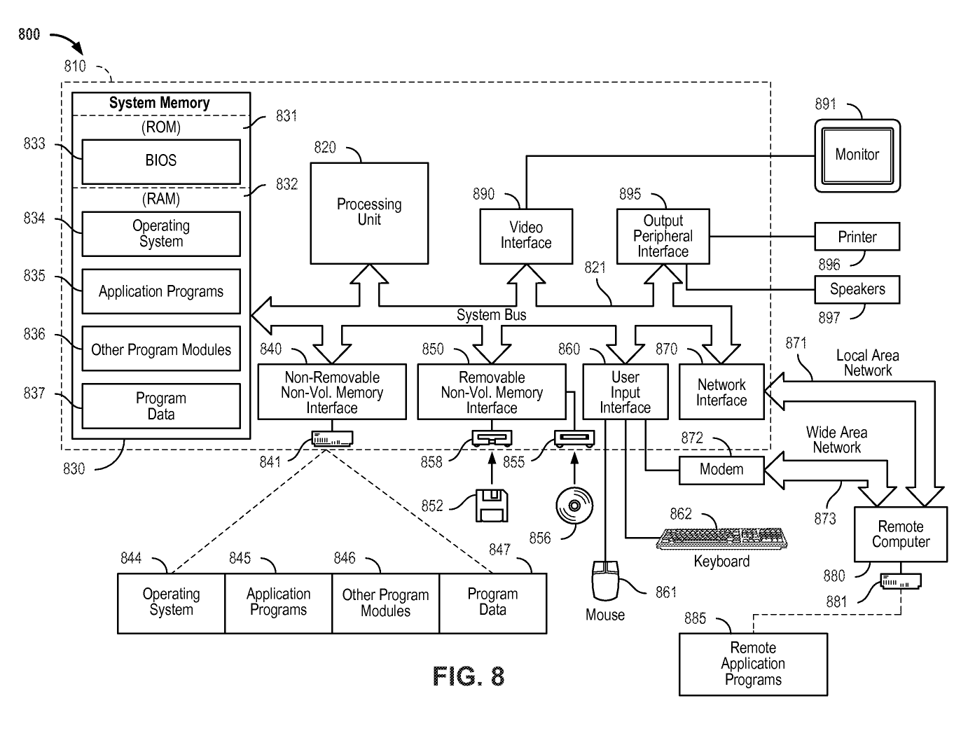

FIG. 8 illustrates an example of a suitable computing system environment 800 on which the technology may be implemented. The computing system environment 800 is only one example of a suitable computing environment and is not intended to suggest any limitation as to the scope of use or functionality of the technology. Neither should the computing environment 800 be interpreted as having any dependency or requirement relating to any one or combination of components illustrated in the exemplary operating environment 800.

The technology is operational with numerous other general purpose or special purpose computing system environments or configurations. Examples of well known computing systems, environments, and/or configurations that may be suitable for use with the technology include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The technology may be described in the general context of computer-executable instructions, such as program modules, being executed by a computer. Generally, program modules include routines, programs, objects, components, data structures, etc. that perform particular tasks or implement particular abstract data types. The technology may also be practiced in distributed computing environments where tasks are performed by remote processing devices that are linked through a communications network. In a distributed computing environment, program modules may be located in both local and remote computer storage media including memory storage devices.

With reference to FIG. 8, an exemplary system for implementing the technology includes a general purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable, volatile/nonvolatile computer storage media. By way of example only, FIG. 8 illustrates a hard disk drive 840 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies. A user may enter commands and information into the computer 20 through input devices such as a keyboard 862 and pointing device 861, commonly referred to as a mouse, trackball or touch pad. Other input devices (not shown) may include a microphone, joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. In addition to the monitor, computers may also include other peripheral output devices such as speakers 897 and printer 896, which may be connected through an output peripheral interface 890.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on memory device 881. It will be appreciated that the network connections shown are exemplary and other means of establishing a communications link between the computers may be used.

While the technology will be described as implemented in the context of the system of FIG. 4, it will be recognized that application of the principles of the technology are not limited to a private or enterprise system, or a single email domain.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A method for balancing request load in a network system including a plurality of clients interacting with a plurality of servers, comprising:
for each request, resolving a name record to obtain a plurality of network endpoints identifying servers capable of completing the transaction;
randomly selecting one of the plurality of endpoints;
initiating the transaction with the server at the selected endpoint; and
determining whether to initiate future requests to the server at said endpoint based on the result of the request.

2. The method of claim 1 wherein the step of resolving comprises receiving a Domain Name Service (DNS) A record having a plurality of addresses associated with said host name.

3. The method of claim 1 wherein the step of resolving comprises receiving an DNS mail exchange (MX) record having a plurality of addresses associated with said host name.

4. The method of claim 3 wherein the MX record includes a subset of real addresses having a specified priority within the record.

5. The method of claim 1 wherein the step of determining includes the step of tracking the number of requests which fail for a selected endpoint.

6. The method of claim 5 further including the step of inhibiting future requests to the selected endpoint if the number of consecutive failed transactions exceeds a threshold number.

7. The method of claims 6 further including restoring transactions to the selected endpoint after a period of time has expired.

8. The method of claim 1 further including the step of selecting a second one the plurality of endpoints and repeating said step of initiating and said step of reporting for said second one of the plurality of endpoints.

9. The method of claim 1 wherein the transaction is one of a request for email data from a server at the endpoint, a request for a list of DNS servers, a request for a list of directory servers, or a request for a cluster of application servers.

10. A method for balancing load in a network system, the system including a plurality of clients initiating transactions with a plurality of servers, comprising:
specifying for each transaction a name associated with one or more servers capable of completing the transaction;
in response to a request from a client, providing a plurality of IP addresses associated with the name, each IP address identifying one of the plurality of servers capable of completing the transaction; and
determining whether to initiate future requests to the server at said address based on the result of the request.

11. The method of claim 10 wherein the step of providing comprises returning a DNS A record having a plurality of addresses associated with said name.

12. The method of claim 10 wherein the step of providing comprises returning an DNS MX record having a plurality of addresses associated with said name.

13. The method of claim 12 further including weighting the addresses by transactional load capability.

14. The method of claim 10 further including the step of tracking the number of transactions which fail for a selected IP address.

15. The method of claim 14 further including the step of inhibiting transactions to the selected IP address if the number of consecutive failed transactions exceeds a threshold number.

16. The method of claims 15 further including restoring transactions to the selected IP address after testing whether a transaction to the IP address succeeds after a period of time has expired.

17. A computer-readable medium having computer-executable instructions for performing steps comprising:
receiving a request to perform a transaction by a client within the controlled networking system, the request including a name identifying a transaction server specified in the networking system to perform the transaction;
resolving the name record by providing a plurality of IP addresses of transaction servers available to perform the transaction;
receiving an indication of whether the transaction succeeded for an IP address; and
determining whether to initiate future requests to the server at said IP address based on the result of a number of consecutive requests to the IP address.

18. The method of claim 17 further including inhibiting transactions to the IP if a number of transactions to the IP are not completed.

19. The method of claim 18 further including restoring transactions to the IP after a specified time period.

20. The method of claim 18 further including testing whether a new transaction to the IP succeeds after a period of time.
